(19) United States
(12) Patent Application Publication
(10) Pub. No.: US 2023/0230507 A1
(43) Pub. Date: Jul. 20, 2023

(54) APPARATUS AND METHOD FOR VISUALIZING A ROOM LAYOUT

(71) Applicants: Wanda Russell, Upper Marlboro, MD (US); Eastmond Buckner, Upper Marlboro, MD (US); Preston Russell, Upper Marlboro, MD (US); Aaron C. Butler, Upper Marlboro, MD (US)

(72) Inventors: Wanda Russell, Upper Marlboro, MD (US); Eastmond Buckner, Upper Marlboro, MD (US); Preston Russell, Upper Marlboro, MD (US); Aaron C. Butler, Upper Marlboro, MD (US)

(21) Appl. No.: 18/093,500

(22) Filed: Jan. 5, 2023

Related U.S. Application Data
(60) Provisional application No. 63/300,601, filed on Jan. 18, 2022.

(51) Int. Cl. G09B 25/00

(52) U.S. Cl. CPC G09B 25/00

(57) ABSTRACT

An apparatus and method for visualizing a layout of one or more objects, such as furniture in an enclosed space, such as a room. The apparatus includes flexible and foldable sheets, wherein the dimensions of the sheets correspond to the floor area occupied by the respective objects. The sheets can be placed in a room to visualize how the objects can be placed or appear or fit in the room.

### CROSS-REFERENCE TO RELATED APPLICATIONS

This application claims priority from a U.S. Provisional Patent Appl. No. 63/300,601 filed on Jan. 18, 2022, which is incorporated herein by reference in its entirety.

### FIELD OF INVENTION

The present invention relates to a system and method for visualizing a room layout, and more particularly, the present invention relates to a portable and compact system for visualizing the layout of objects, such as furniture in a room.

### BACKGROUND

It is common to visualize a layout of a room, before placing objects, such as furniture in a room. It is easier to arrange and rearrange small articles in a room to find the best spot for placing the articles. However, with bigger articles, such as beds, it is difficult to move or rearrange large furniture items. Moreover, before buying large articles, it is advisable to confirm if the article will fit into the room. Moving to a new place can be very laborious as one does not know which furniture will fit into the new place and the best place for the same.

Visualization technology is available that allows preparing virtual 2D and 3D layouts of rooms and buildings. The position of different objects including furniture can be visualized on a screen. However, preparing such layouts is time-consuming and costly.

A need is therefore appreciated for a system that allows visualizing a room layout easily and cost-effectively.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for visualizing a layout of a room.

It is another object of the present invention that the system is economical to manufacture and use.

It is still another object of the present invention that the system can be easily designed for a new article.

It is an additional object of the present invention that the system can be folded for storage and transport.

In one aspect, disclosed is an apparatus and method for visualizing a layout of one or more objects in an enclosed space, the method comprising providing one or more sheets, wherein dimensions of the one or more sheets correspond to a floor area occupied by the respective one or more objects; and placing the one or more sheets in the enclosed space. The one or more objects comprise a bed, the one or more sheets comprise a sheet for the bed, wherein the sheet of the bed has a plurality of fold lines, wherein the sheet of the bed is configured to be folded along one or more of the plurality of fold lines to switch between different sizes of the bed. The sheet for the bed further comprises dimensions printed adjacent to each of the plurality of fold lines. The one or more sheets are flexible and foldable. The one or more sheets further comprises a sheet for a dresser, a sheet for a bedside table, and a sheet for a chest. The one or more sheets further comprises a sheet for a sofa and a sheet for a center table. The sheet for the sofa is configured to be folded to switch between dimensions of distinct types of sofa. The method further comprises upon placing, repositioning at least one of one or more sheets at a different location in the enclosed space.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 illustrates a unit of the system for visualizing the placement of a dresser, according to an exemplary embodiment of the present invention.

FIG. 2 shows another unit of the system for visualizing the placement of a Full & Twin Bed, according to an exemplary embodiment of the present invention.

FIG. 3 shows another unit of the system for visualizing the placement of the King & Queen bed, according to an exemplary embodiment of the present invention.

FIG. 4 shows another unit of the system for visualizing the placement of a Drawer Chest (Ottoman, Buffet), according to an exemplary embodiment of the present invention.

FIG. 5 shows another unit of the system for visualizing the placement of a nightstand, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form to facilitate describing the subject innovation.

Disclosed are an apparatus and method for visualizing a layout of a room. The room includes any space in a building, such as a living room, kitchen, restroom, and the like. The disclosed apparatus includes flexible and foldable sheets of dimensions corresponding to a floor area occupied by objects. Such objects are meant to be placed in a room and include furniture, home devices, and the like. Preferably, the objects are larger in size or heavy in profile. The sheets corresponding to respective objects can be laid in a room to visualize how the objects can be arranged in the room or will the object fit into the room or the place of the object in the room

The sheets can be made from plastic material that is light in weight, thin, flexible, and durable. The sheets can be thick enough to remain in shape and to be easily placed on a floor. The thickness and weight of the sheet can allow it to be placed and positioned by one person. For different objects, corresponding sheets can be made that can be used to visualize the placement of the respective object.

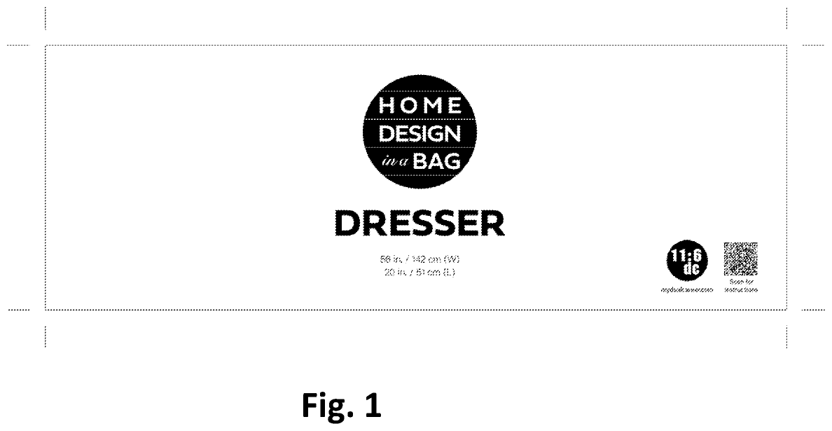

In one implementation, the apparatus includes PEVA (polyethylene vinyl acetate) material sheets with a printed overlay which correspond to the average sizes of furniture items such as a Dresser, Full & Twin Bed, King & Queen Bed, Drawer Chest, and Nightstand. FIGS. 1-5 show the sheets for different furniture including the bed and dresser. The sheets are white with black printing. The printing includes the sheet size, the name of the object the sheet represents, and the folding instructions for the sheet. The layout of the furniture can also be illustrated on the sheet, such as the front side of the furniture, or the position of drawers, doors, and the like. Company branding can also be printed on the sheets.

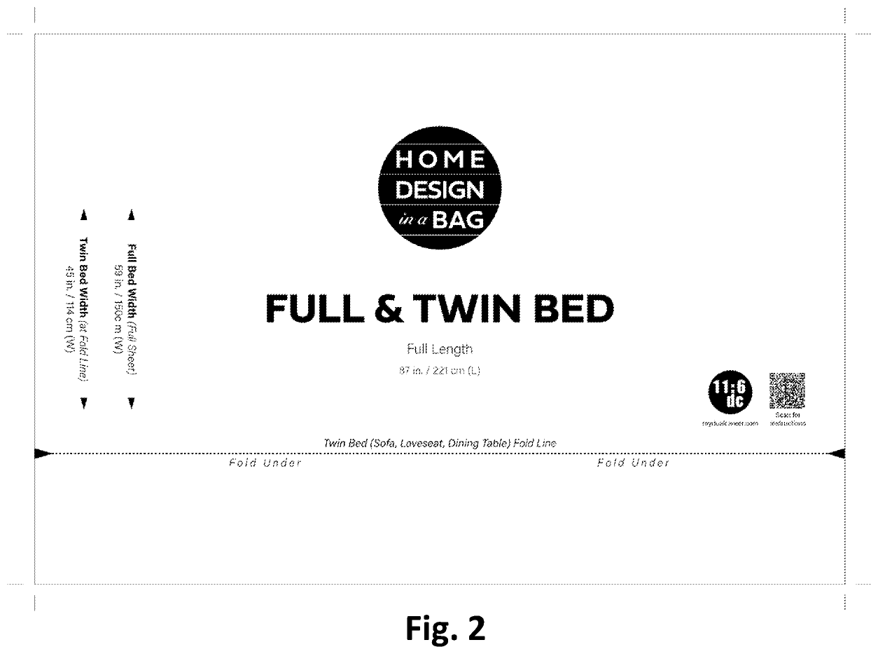

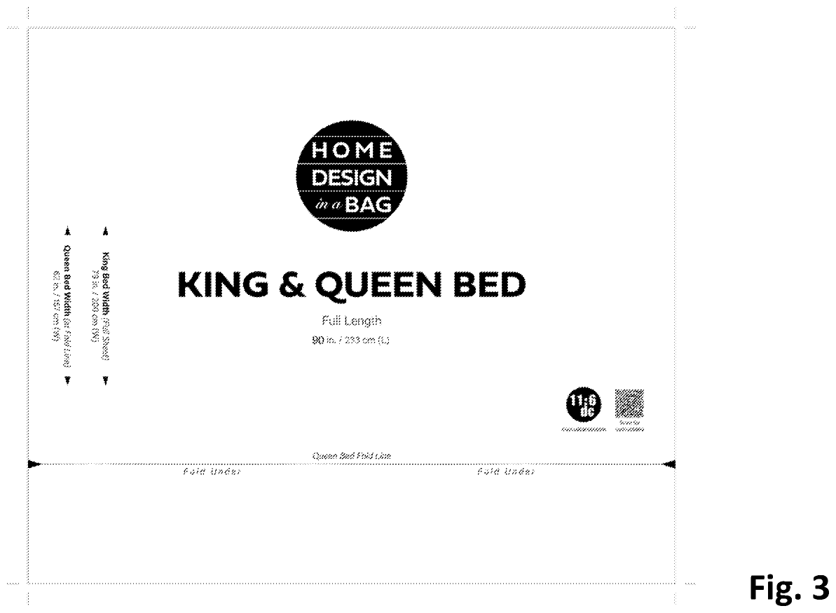

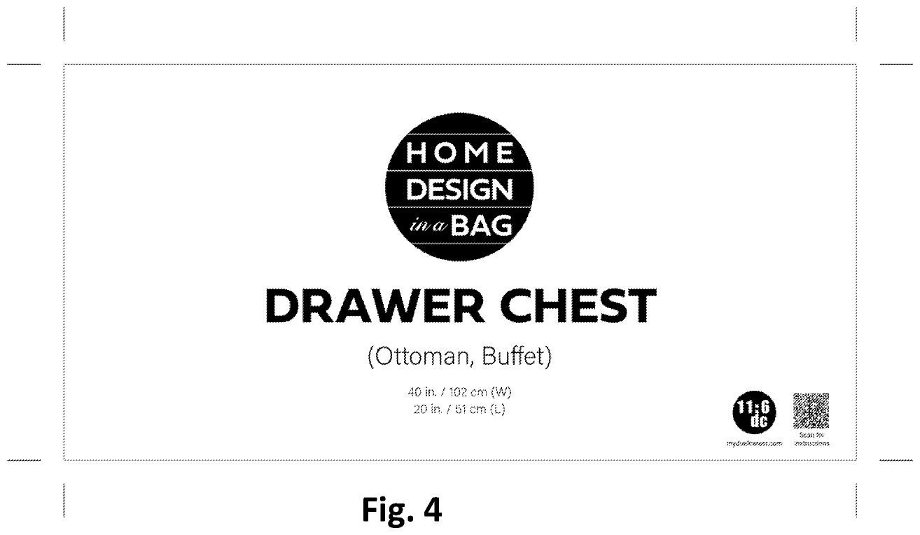

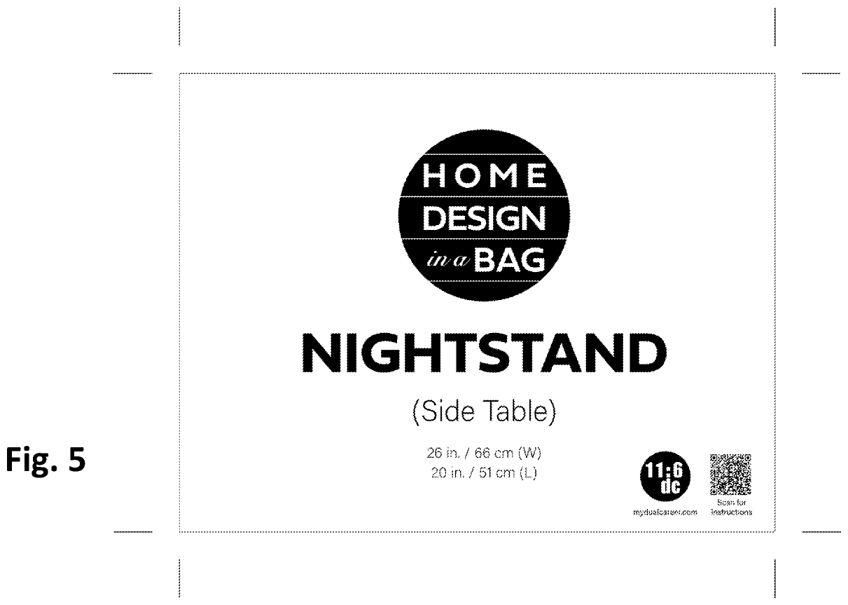

FIG. 1 shows a sheet for a dresser that can be about 56″×20″ in size. FIG. 2 shows a sheet for a Full & Twin Bed and has a dimension of about 87″×59″. FIG. 3 shows another sheet for a King & Queen size bed that can be about 90″×79″. FIG. 4 shows a sheet for a Drawer Chest (Ottoman, Buffet) which can be about 40″×20″. Another sheet is shown in FIG. 5 which can be for a Nightstand (Side Table) and can be about 26″×20″ in dimensions. It is understood, that for objects of varied sizes and shapes, a corresponding sheet can be made.

A user can place the sheets in a room to determine potential layouts for the furniture and size limitations for the furniture. The user when switching to a new home can check if existing furniture will fit into the desired spaces at the new home. The user does not have to place and reposition the furniture which is both laborious and time-consuming. Moreover, rearranging the furniture may result in damage. Using the disclosed apparatus, the user may know if the furniture can fit into a new place and the best place or spot for the respective furniture. The user also before buying a new furniture can check if the new furniture can fit into the given space. The user can be provided with a sheet of the furniture and the user can check before buying the furniture. The sheet can be provided by the seller or the manufacturer of the object or any other person.

The disclosed apparatus allows having one sheet for one object, one sheet for related objects, and multiple sheets for multiple objects. The disclosed apparatus alleviates the need for positioning and repositioning the furniture to determine potential layouts and designs for interior spaces.

In one case, a user can determine the layout of objects in an empty bedroom. The user can envision the layout of the furniture without needing to actually place the furniture and repeatedly reposition the furniture to find the best spot. The user may remove the sheets from the package of the apparatus corresponding to the furniture items the user wants to place in the room space. The user can then unfold the sheets and lay them on the floor to visualize the layout of the actual furniture items. For sheets that have multiple uses, the user can use the fold guides printed on the sheets to achieve the desired size.

In one implementation, a single sheet can be adapted for different size objects by folding and unfolding along the fold lines. For example, the same sheet can be used for king-size and queen-size beds. Fold lines with written instructions can be made on the sheet and the sheet can be folded along these fold lines to switch between sheets for king and queen-size beds. Thus, by using the same sheet, the user can visualize if a smaller or larger size bed will better fit into the given space. The sheet can also be provided with a scale and fold lines along the scale, which allows for making custom-size sheets.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for visualizing a layout of one or more objects in an enclosed space, the method comprising:
providing one or more sheets, wherein dimensions of the one or more sheets correspond to a floor area occupied by the respective one or more objects; and
placing the one or more sheets in the enclosed space.

2. The method according to claim 1, wherein the one or more objects comprise a bed, the one or more sheets comprise a sheet for the bed, wherein the sheet of the bed has a plurality of fold lines, wherein the sheet of the bed is configured to be folded along one or more of the plurality of fold lines to switch between different sizes of the bed.

3. The method according to claim 2, wherein the sheet for the bed further comprises dimensions printed adjacent to each of the plurality of fold lines.

4. The method according to claim 1, wherein the one or more sheets are flexible and foldable.

5. The method according to claim 2, wherein the one or more sheets further comprises a sheet for a dresser, a sheet for a bedside table, and a sheet for a chest.

6. The method according to claim 5, wherein the one or more sheets further comprises a sheet for a sofa and a sheet for a center table.

7. The method according to claim 6, wherein the sheet for the sofa is configured to be folded to switch between dimensions of different types of sofa.

8. The method according to claim 1, wherein the method further comprises:
upon placing, repositioning at least one of one or more sheets at a different location in the enclosed space.

9. An apparatus for visualizing a layout of one or more objects in an enclosed space, the apparatus comprising:
one or more sheets, wherein dimensions of the one or more sheets correspond to a floor areas occupied by the respective one or more objects.

10. The apparatus according to claim 9, wherein the one or more objects comprise a bed, the one or more sheets comprises a sheet for the bed, wherein the sheet of the bed has a plurality of fold lines, wherein the sheet of the bed is configured to be folded along one or more of the plurality of fold lines to switch between different sizes of the bed.

11. The apparatus according to claim 10, wherein the sheet for the bed further comprises dimensions printed adjacent to each of the plurality of fold lines.

12. The apparatus according to claim 9, wherein the one or more sheets are flexible and foldable.

13. The apparatus according to claim 10, wherein the one or more sheets further comprises a sheet for a dresser, a sheet for a bedside table, and a sheet for a chest.

14. The apparatus according to claim 13, wherein the one or more sheets further comprises a sheet for a sofa and a sheet for a center table.
